(19) United States
(12) Patent Application Publication
(10) Pub. No.: US 2016/0363262 A1
(43) Pub. Date: Dec. 15, 2016

(54) Mounting Device

(71) Applicant: Connor Moelmann, Glen Ellyn, IL (US)

(72) Inventor: Connor Moelmann, Glen Ellyn, IL (US)

(21) Appl. No.: 15/178,839

(22) Filed: Jun. 10, 2016

Related U.S. Application Data
(60) Provisional application No. 62/173,663, filed on Jun. 10, 2015.
(60) Provisional application No. 62/247,523, filed on Oct. 28, 2015.

(51) Int. Cl. F16M 13/02; B60R 11/02; F16B 47/00; F16B 1/00; H01F 7/02; F16M 13/00

(52) U.S. Cl. CPC F16M 13/022; H01F 7/0205; F16M 13/005; F16B 47/003; F16B 1/00; B60R 11/02; F16B 2001/0035

(57) ABSTRACT

The present disclosure provides a mounting device including a mounting pad having a top surface and a bottom surface, wherein the top surface includes a pair of extrusions. The device also includes a base plate including a pair of cutouts, wherein a bottom surface of the base plate contacts the top surface of the mounting pad such that the pair of cutouts are positioned around the pair of extrusions. Further, the device includes a snap lock moveable between a first position and a second position within a channel in the base plate, wherein the snap lock couples the base plate to the mounting pad in the first position, and wherein the snap lock decouples the base plate from the mounting pad in the second position. Finally, the device includes a biasing element positioned within the channel in the base plate that biases the snap lock to the first position.

### RELATED APPLICATIONS

This application claims priority to (i) U.S. Provisional Application No. 62/173,663 entitled “Mounting Device,” filed on Jun. 10, 2015, and (ii) U.S. Provisional Application No. 62/247,523 entitled “Mounting Device,” filed on Oct. 28, 2015, both of which are hereby incorporated by reference in their entirety.

### BACKGROUND

Unless otherwise indicated herein, the materials described in this section are not prior art to the claims in this application and are not admitted to be prior art by inclusion in this section.

The portability of devices is becoming increasingly important to consumers. However, there are times when it may be advantageous for such devices to remain stationary for a given time period. For example, it may be desirable to temporarily mount a portable electronic device to a vehicle, such as a golf cart, lawnmower, boat, or all-terrain vehicle (ATV). As such, an improved mounting device is described herein for temporarily mounting a device to a surface.

### SUMMARY

Thus, in one aspect, a device is provided for temporarily mounting a device to a surface. The device includes a mounting pad having a top surface and a bottom surface, wherein the top surface includes a pair of extrusions. The device also includes a base plate including a pair of cutouts, wherein a bottom surface of the base plate contacts the top surface of the mounting pad such that the pair of cutouts are positioned around the pair of extrusions. The device includes a snap lock moveable between a first position and a second position within a channel in the base plate, wherein the snap lock couples the base plate to the mounting pad in the first position, and wherein the snap lock decouples the base plate from the mounting pad in the second position. Further, the device includes a biasing element positioned within the channel in the base plate, wherein the biasing element biases the snap lock to the first position.

In a second aspect, a method is provided for temporarily mounting a device to a surface. The method may include (a) positioning a bottom surface of a mounting pad on a surface, wherein a top surface includes a pair of extrusions, (b) positioning a snap lock within a channel in a base plate, wherein the base plate includes a pair of cutouts, and wherein the snap lock is moveable between a first position and a second position within the channel in the base plate, and (c) sliding a bottom surface of the base plate along the top surface of the mounting pad until the snap lock moves from the second position to the first position, thereby coupling the base plate to the mounting pad.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 illustrates a perspective view of a mounting device, according to an example embodiment.

FIG. 2 illustrates a top view of a mounting device, according to an example embodiment.

FIG. 3 illustrates a perspective view of a snap lock of a mounting device, according to an example embodiment.

FIG. 4 illustrates a perspective view of a base plate of a mounting device, according to an example embodiment.

FIG. 5 illustrates a perspective view of a cover plate of the mounting device, according to an example embodiment

FIG. 6 illustrates a perspective view of a mounting pad of a mounting device, according to an example embodiment.

FIG. 7 illustrates a side view of a mounting pad of a mounting device, according to an example embodiment.

FIG. 8 illustrates a top view of a mounting pad of a mounting device, according to an example embodiment.

FIG. 9 illustrates a bottom perspective view of another example mounting pad of a mounting device, according to an example embodiment.

FIG. 10 illustrates a tripod mount for a mounting pad of a mounting device, according to an example embodiment.

FIG. 11 illustrates a screw mount for a mounting pad of a mounting device, according to an example embodiment.

FIG. 12 illustrates a strap mount for a mounting pad of a mounting device, according to an example embodiment.

FIG. 13 illustrates a mounting pad including a lock mount, according to an example embodiment.

FIG. 14 illustrates a mounting pad including an extension member, according to an example embodiment.

FIG. 15 illustrates the mounting device in an unlocked mode during operation, according to an example embodiment.

FIG. 16 illustrates the mounting device transitioning from an unlocked mode to a locked mode during operation, according to an example embodiment.

FIG. 17 illustrates the mounting device in a locked mode during operation, according to an example embodiment.

FIG. 18 illustrates perspective view of another example mounting device, according to an example embodiment.

FIG. 19 illustrates a perspective view of a top surface of another example base plate of a mounting device, according to an example embodiment.

FIG. 20 illustrates a bottom view of the base plate of the mounting device, according to an example embodiment.

FIG. 21 illustrates a perspective view of an example rectangular object coupled to the base plate of the mounting device via a pair of straps, according to an example embodiment.

FIG. 22 illustrates a side view of the example rectangular object coupled to the base plate of the mounting device via a pair of straps, according to an example embodiment.

FIG. 23 illustrates a perspective view of a top surface of the base plate of the mounting device including a pair of curve guides, according to an example embodiment.

FIG. 24 illustrates a perspective view of an example cylindrical object coupled to the base plate of the mounting device via a pair of straps, according to an example embodiment.

FIG. 25 illustrates another perspective view of the example cylindrical object coupled to the base plate of the mounting device via a pair of straps, according to an example embodiment.

FIG. 26 illustrates a side view of the example cylindrical object coupled to the base plate of the mounting device via a pair of straps, according to an example embodiment.

FIG. 27 illustrates a zoomed in side view of the example cylindrical object coupled to the base plate of the mounting device via a pair of straps, according to an example embodiment.

FIG. 28 illustrates a perspective view of the base plate built into an object, according to an example embodiment.

FIG. 29 illustrates a perspective view of the base plate built into an object, according to another example embodiment.

### DETAILED DESCRIPTION

Example methods and systems are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

As used herein, with respect to measurements, “about” means+/−5%.

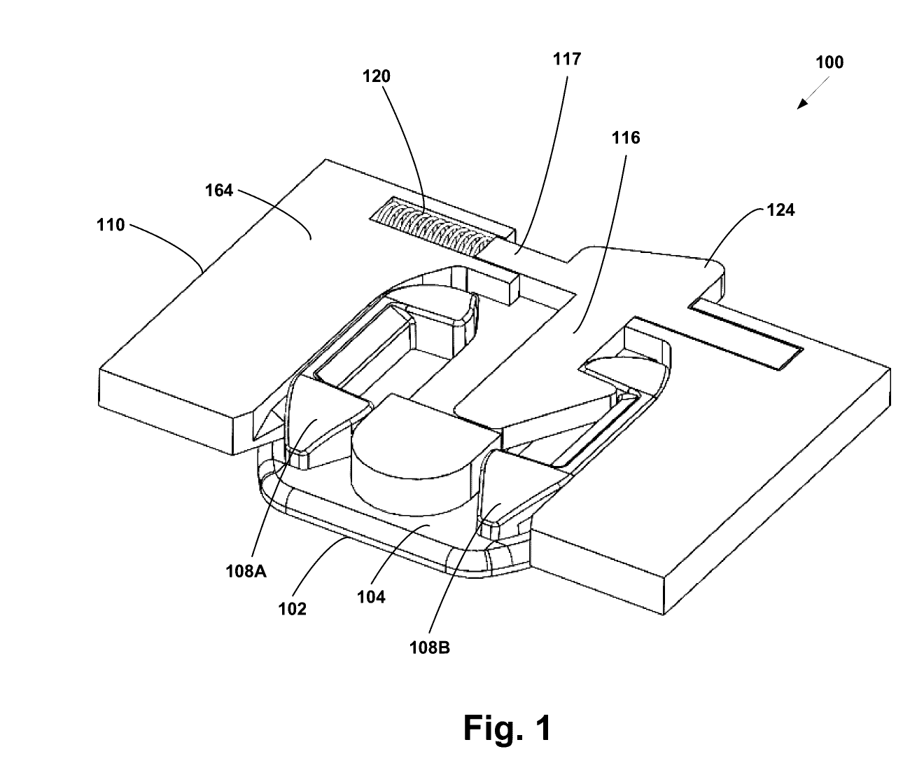

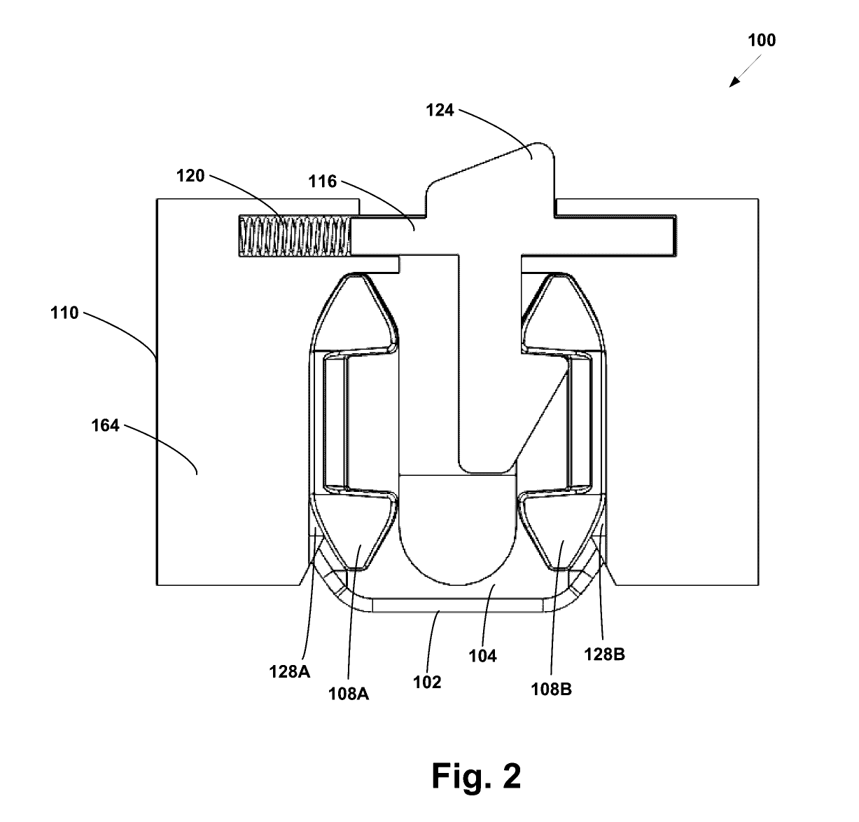

With reference to the Figures, FIG. 1 illustrates an example mounting device 100. The mounting device 100 may include a mounting pad 102 having a top surface 104 and a bottom surface 106. The top surface 104 of the mounting pad 102 may include a pair of extrusions 108A, 108B. The mounting device 100 also includes a base plate 110 including a pair of cutouts 112A, 112B. A bottom surface 114 of the base plate 110 contacts the top surface 104 of the mounting pad 102 such that the pair of cutouts 112A, 112B are positioned around the pair of extrusions 108A, 108B. The mounting device 100 also includes a snap lock 116 moveable between a first position and a second position within a channel 118 in the base plate 110. The snap lock 116 couples the base plate 110 to the mounting pad 102 in the first position, and the snap lock 116 decouples the base plate 110 from the mounting pad 102 in the second position. Further, the mounting device 100 includes a biasing element 120 positioned within the channel 118 in the base plate 110. The biasing element 120 is configured to bias the snap lock 116 to the first position. The biasing element 120 may be a compression spring, but may take other forms as well. FIG. 2 is a top view of the mounting device 100. As shown in FIG. 2, the snap lock 116 is in the first position such that the base plate 110 is coupled to the mounting pad 102.

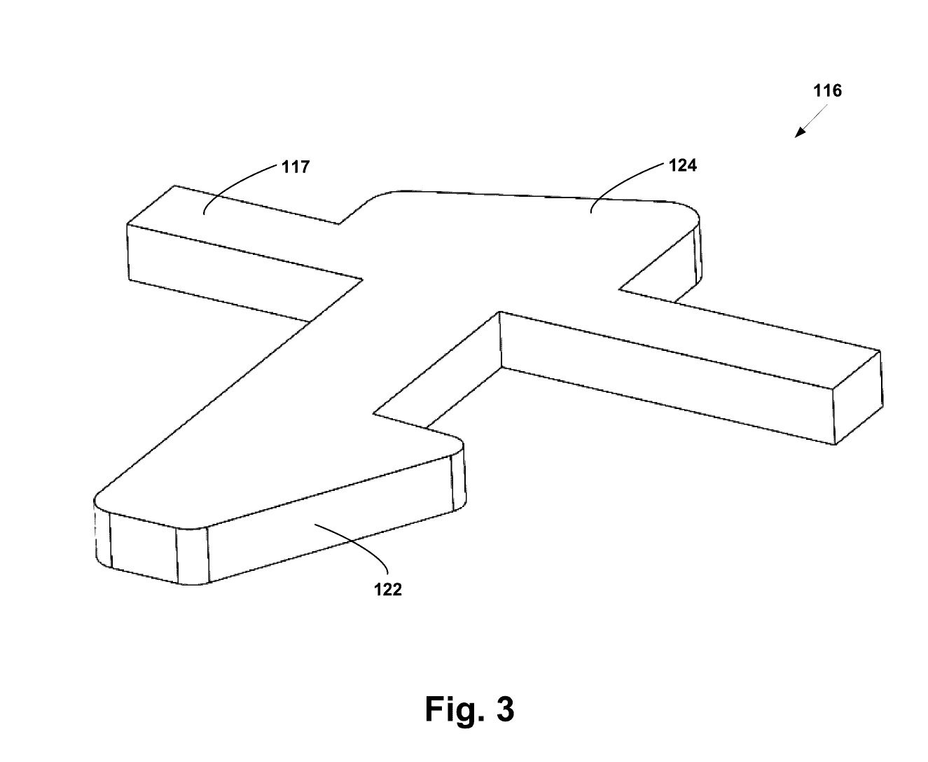

FIG. 3 illustrates an example snap lock 116, according to an example embodiment. The snap lock 116 includes an angled surface 122. In use, as the angled surface 122 of the snap lock 116 contacts one of the angled surfaces 109A, 109B of the extrusions 108A, 108B of the mounting pad 102, the snap lock 116 moves from the first position to the second position. Further, once the angled surface 122 of the snap lock 116 moves past the angled surface 109A, 108B of the extrusion 108A, 108B, the snap lock 116 will move rapidly back to the first position due to the biasing element 120. The snap lock 116 may include a latch 124, as shown in FIG. 3 that may be used to cause the snap lock 116 to move from the first position to the second position. The latch 124 may include a groove to more ergonomically accept a thumb or finger of a user as the user moves the snap lock 116 from the first position to the second position. In another embodiment, as discussed in additional detail below, the snap lock 116 may not include the latch 124 such that the side opposite the angled surface 122 is substantially straight to fit within the channel 118. The snap lock 116 may further include an elongated section 117 shaped to fit within the channel 118. In use, a first end of the elongated section 117 contacts the biasing element 120 as the snap lock 116 moves from the first position to the second position.

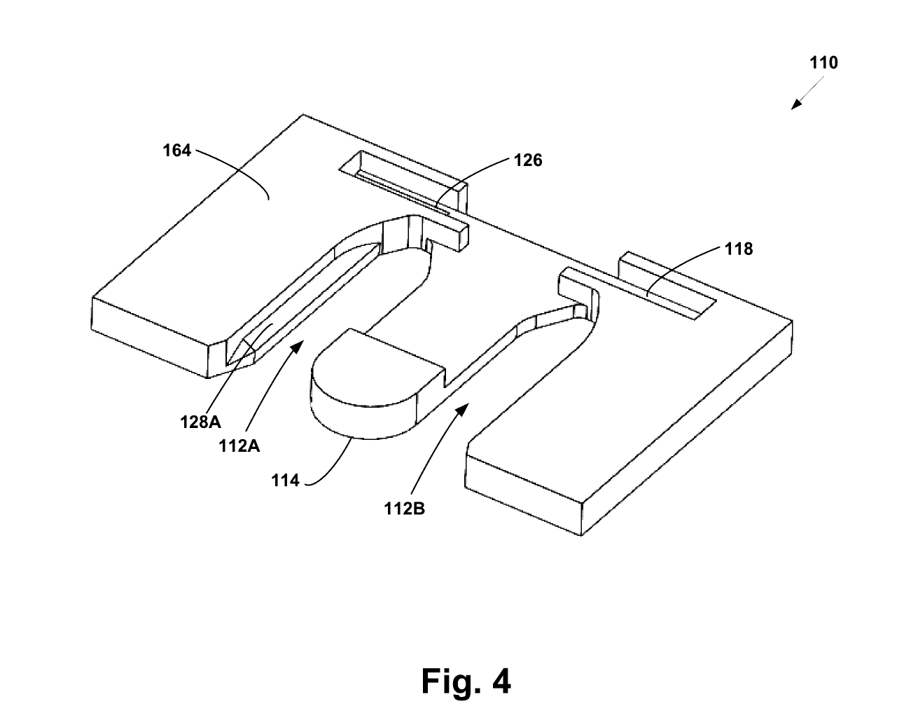

FIG. 4 illustrates a perspective view of the base plate 110 of the mounting device 100, according to an example embodiment. As shown in FIG. 4, the base plate 110 includes two cutouts 112A, 112B on the bottom surface 114, as well as a channel 118. One side of the channel 118 may include additional an additional cutout 126 in which the biasing element 120 is positioned as the snap lock 116 moves from the first position to the second position. The base plate 110 may further include a pair of angled surfaces 128A, 128B adjacent the pair of cutouts 112A, 112B.

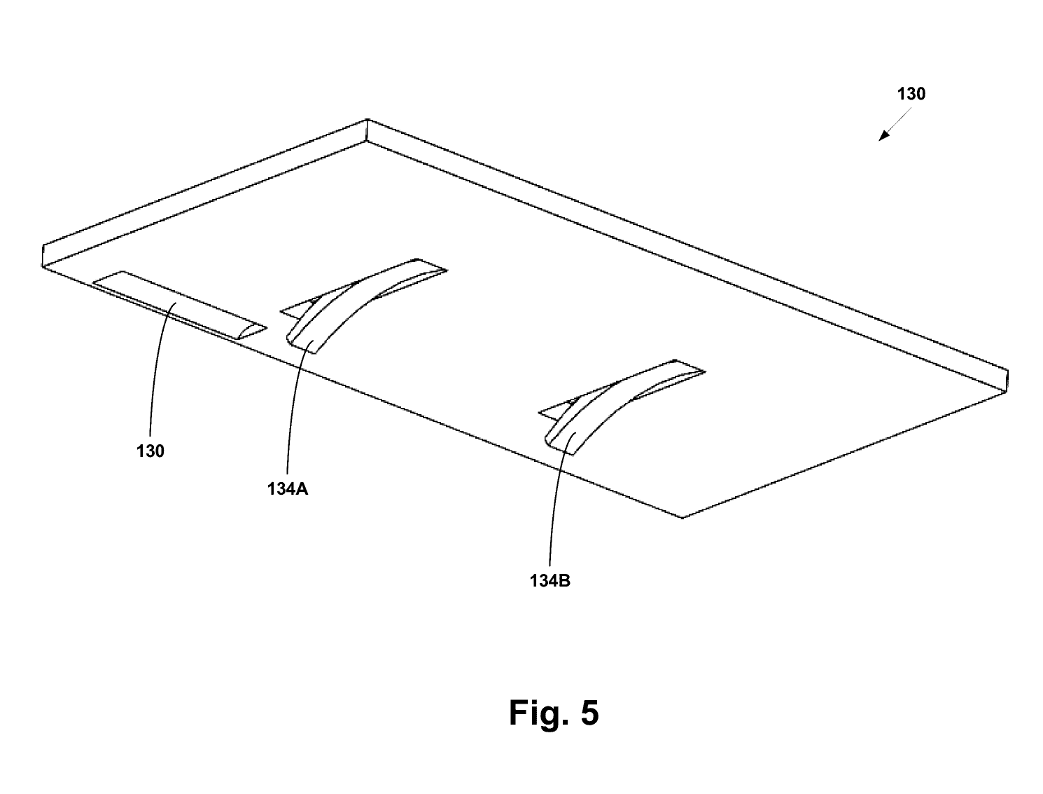

FIG. 5 illustrates a perspective view of a cover plate 130 of the mounting device 100, according to an example embodiment. The cover plate 130 may be positioned on top of the base plate 110 to hold the biasing element 120 in place and keep the snap lock 116 in the channel 118 as the snap lock 116 moves from the first position to the second position. As shown in FIG. 5, the cover plate 110 may include a cutout 132 in which the biasing element 120 may be positioned. Further, the cover plate 110 may include a pair of dampers 134A, 134B to reduce vibrations between the base plate 110 and the mounting pad 102 when the two components are coupled together.

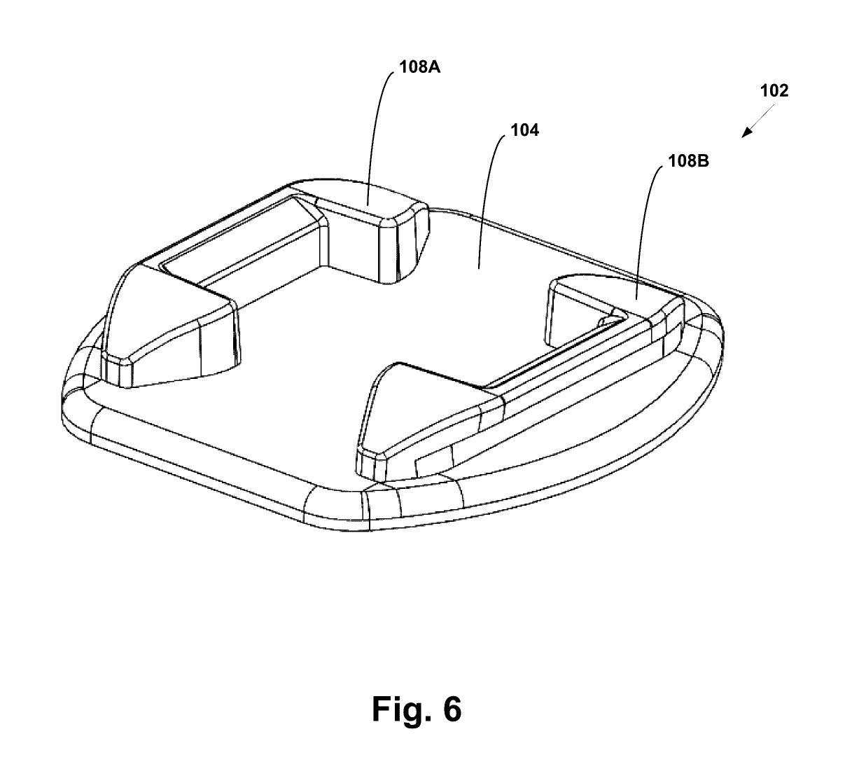

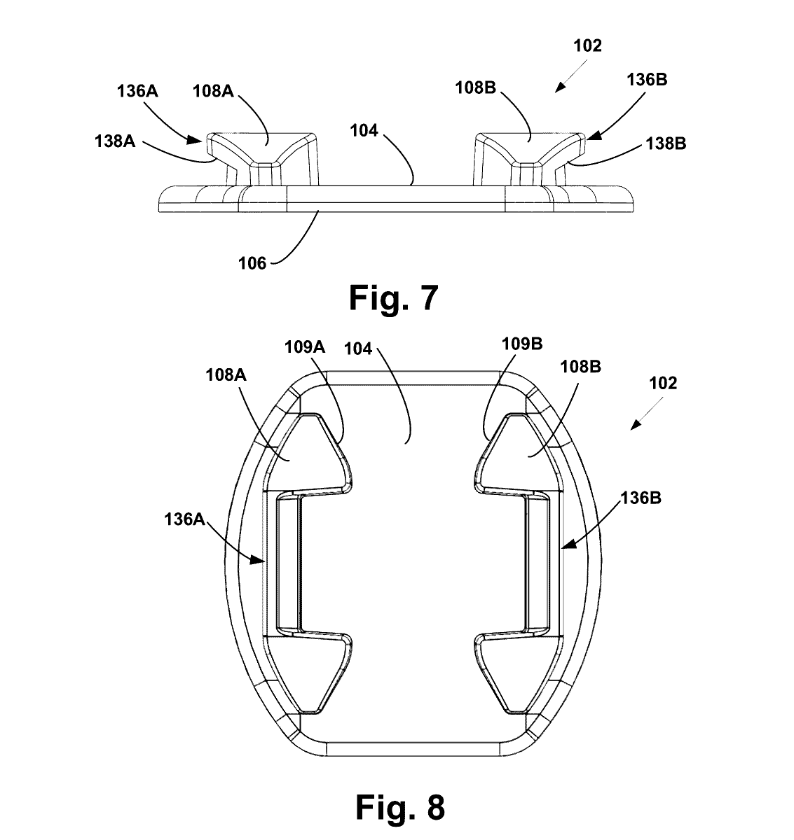

FIGS. 6-8 illustrate various views of the mounting pad 102 of the mounting device 100, according to example embodiments. As shown in FIGS. 6-8, the mounting pad 102 includes a top surface 104 and a bottom surface 106, with a pair of extrusions 108A, 108B extending from the top surface 104. As shown in FIG. 7, the outer edge 136A, 136B of each of the extrusions 108A, 108B may include an angled surface 138A, 138B. Such an angled surface 138A, 138B may be complementary to the angled surface 128A, 128B of the base plate 110 as discussed in relation to FIG. 4. In particular, the angled surface 128A, 128B of the base plate 110 may be flush against the angled surface 138A, 138B of the extrusions 108A, 108B when the base plate 110 and the mounting pad 102 are coupled together. As such, the angled surface 138A, 138B of the extrusions 108A, 108B prevent the base plate 100 from moving vertically when the base plate 110 is coupled to the mounting pad 102. In one example, the bottom surface 106 of the mounting pad 102 may be substantially planar, as shown in FIG. 7. In another example, the bottom surface 106 of the mounting pad 102 may have a radius of curvature greater than zero. Such an embodiment may be used to for mounting various objects to curved surfaces.

As shown in FIG. 8, the extrusions 108A, 108B of the mounting pad 102 may further include angled surfaces 109A, 109B. In operation, the angled surfaces 109A, 109B of the extrusions 108A, 108B may help guide the angled surface 122 of the snap lock 116 from the first position to the second position. As discussed above, once the angled surface 122 of the snap lock 116 moves past the angled surface 109A, 108B of the extrusion 108A, 108B, the snap lock 116 will move rapidly back to the first position due to the biasing element 120. Further, as shown in FIG. 8, the mounting pad 102 may be substantially symmetrical such that the base plate 110 can be coupled to the mounting pad 102 from either side.

In addition, the mounting pad 102 may include a mounting mechanism for mounting the bottom surface 106 of the mounting pad 102 to a surface. The surface may be any suitable surface. For example, the surface may be a dashboard of a golf cart, a handlebar in an ATV or bike, a wall, a countertop, or any other suitable surface. In one example, the mounting mechanism for mounting the bottom surface 106 of the mounting pad 102 to a surface may include a permanent sticky pad. In another example, the mounting mechanism for mounting the bottom surface 106 of the mounting pad 102 to a surface may include a temporary sticky pad. In another example, the mounting mechanism for mounting the bottom surface 106 of the mounting pad 102 to a surface may include a suction cup. The suction cup may include a lever bar that rotates to lock and unlock the suction cup to the surface. The lever may rotate past center to lock itself in place with fore from the stretching rubber. Also, in the locked position, the lever may lie flat down in the middle of the mount making it impossible to accidentally release the lever while the base plate is coupled to the mounting pad. In another example, the mounting mechanism for mounting the bottom surface 106 of the mounting pad 102 to a surface may include a bolt mount. Two or more bolts may run perpendicularly downward and there may be a corresponding piece that acts as a clamp and washers. The bolts may include wing nuts that may be tightened by a user. The surface may include complementary mounting holes through which the bolts may pass.

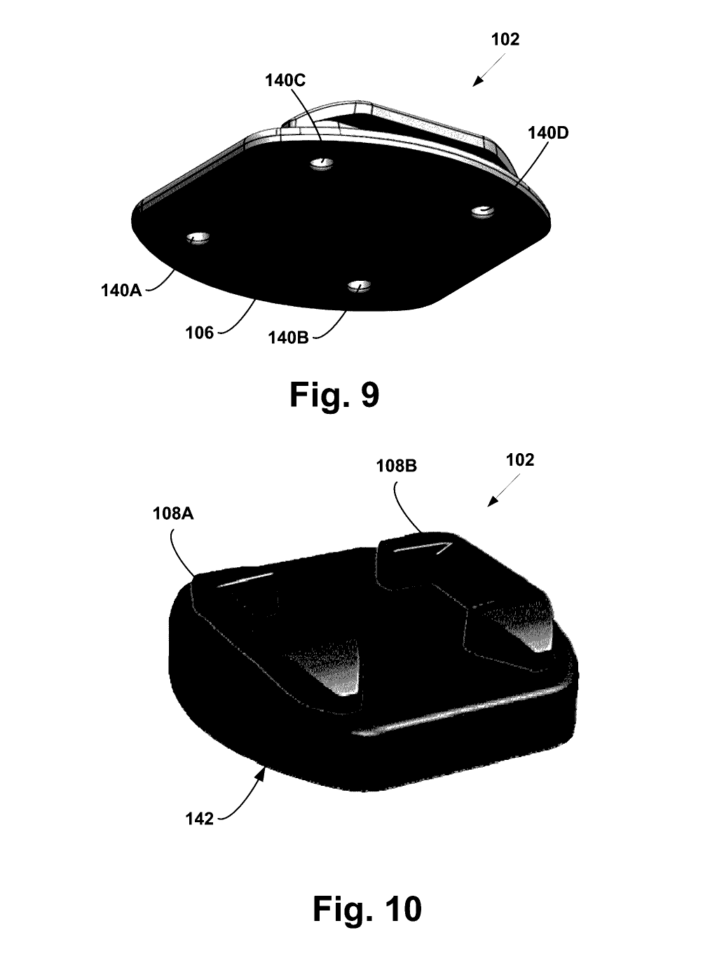

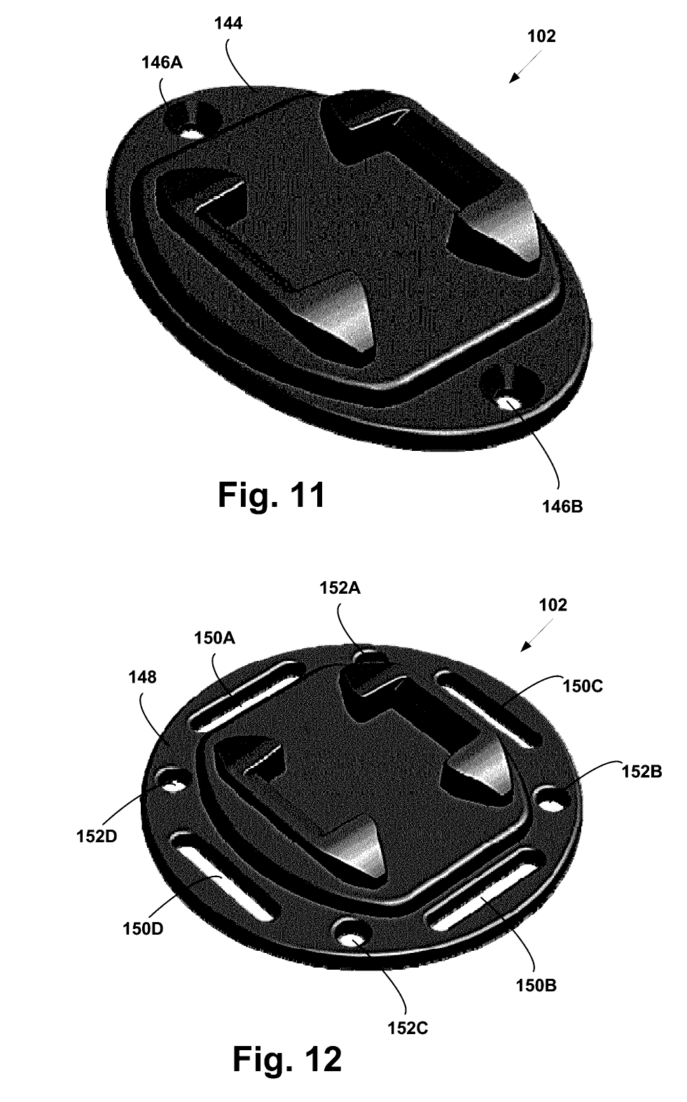

In another example, as shown in FIG. 9, the mounting pad 102 may include a plurality of holes 140A-140D in the bottom surface 106 of the mounting pad 102. These holes 140A-140D may be used to screw the mounting pad 120 into a surface, or the holes 140A-140D may be used to screw the mounting pad 120 into the various mounting mechanisms for mounting the bottom surface 106 of the mounting pad 102 to a surface. For example, as shown in FIG. 10, the mounting pad 102 may be coupled to a tripod mount 142 via one or more screws through the one or more holes 140A-140D in the bottom surface 106 of the mounting pad 120. The tripod mount 142 may include a flange nut on its bottom surface. In one particular example, the flange mount may be a 1/4-20 flange nut. In another example, as shown in FIG. 11, the mounting pad 102 may be coupled to a screw mount 144 via one or more screws through the one or more holes 140A-140D in the bottom surface 106 of the mounting pad 102. The screw mount 144 may include two or more holes 146A, 146B through which screws or nails may be inserted to attach the mounting pad 102 to a wall, or other surface.

In another example, as shown in FIG. 12, the mounting mechanism for mounting the bottom surface 106 of the mounting pad 102 to a surface may include a strap mount 148. The strap mount 148 may be coupled to the mounting pad 102 via one or more screws through the one or more holes 140A-140D in the bottom surface 106 of the mounting pad 102. Such a strap mount 148 may include a nylon strap to wrap around an object and tighten down to act as a firm mount. In one particular example, the strap may include 48″ elastic hook and loop strap. Such a strap may be used to be wrapped around trees, for example. The strap may be threaded through one slot 150A, passed beneath the mounting pad, and then threaded through the opposite slot 150B. As shown in FIG. 12, there may be two sets of slots 150A-150D depending on the orientation of the object to be coupled to the mounting device 102. Further, the strap mount 148 may be attached to existing straps on a backpack, or other bag for example. The strap mount 148 may further include holes 152A-152D that can be used for tying strings to mount the mounting pad 120 in a similar fashion. In another example, the holes 152A-152D may be used as through-holes through which screws or nails may be inserted to attach the mounting pad 102 to a wall, or other surface.

In another example, the mounting mechanism for mounting the bottom surface 106 of the mounting pad 102 to a surface may include a magnet mount. Such a magnet may be built into the mounting pad 102, such that the mounting pad 102 is magnetically attracted to any metal surface. In another example, the mounting mechanism for mounting the bottom surface 106 of the mounting pad 102 to a surface may include a clamp mount with a spring loaded clamp. In another example, the mounting mechanism for mounting the bottom surface 106 of the mounting pad 102 to may include a bar mount that may be used to clamp onto handle bars of a bike, for example, along with other cylindrical shapes. Further, the mounting mechanism for mounting the bottom surface 106 of the mounting pad 102 to a surface may include a rotatable mount. The rotatable mount may include a bottom portion, a pivot point coupled to the bottom portion, and the bottom surface of the mounting pad may be coupled to the pivot point. As such, the rotatable mount may rotate 360 degrees so that you can adjust a position of an object coupled to the base plate 110.

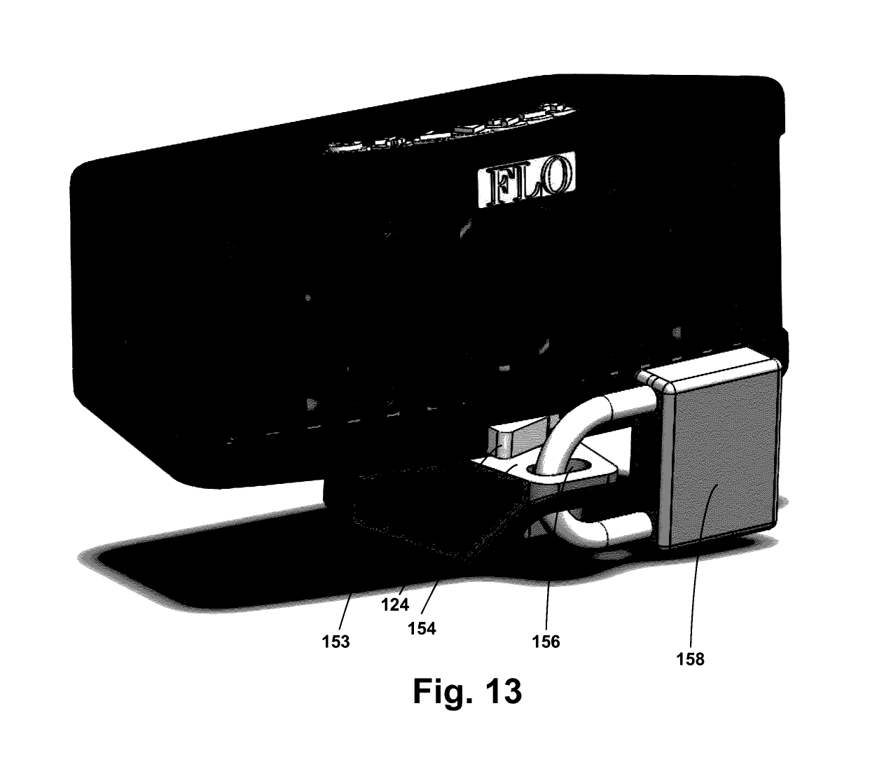

In another example, as shown in FIG. 13, the mounting mechanism for mounting the bottom surface 106 of the mounting pad 102 to a surface may include a lock mount 153. In such an example, the mounting pad 102 may include an extended portion 154 that extends from the mounting pad 102 between the pair of extrusions 108A, 108B. The extended portion 154 may include a hole 156 through which a lock 158 may be positioned. As such, the base plate 110 may not be separated from the mounting pad 102 when the lock 158 is in place because the lock 158 prevents the base plate 110 from moving in the direction towards the extended portion 154. In another example, the latch 124 may also include a hole that aligns with the hole 156 in the extended portion 154 when the mounting pad 102 is coupled to the base plate 110. In such an example, the lock 158 may be positioned through both the hole in the latch 124 and the hole 156 in the extended portion to thereby prevent the base plate 110 from moving in the direction towards the extended portion 154.

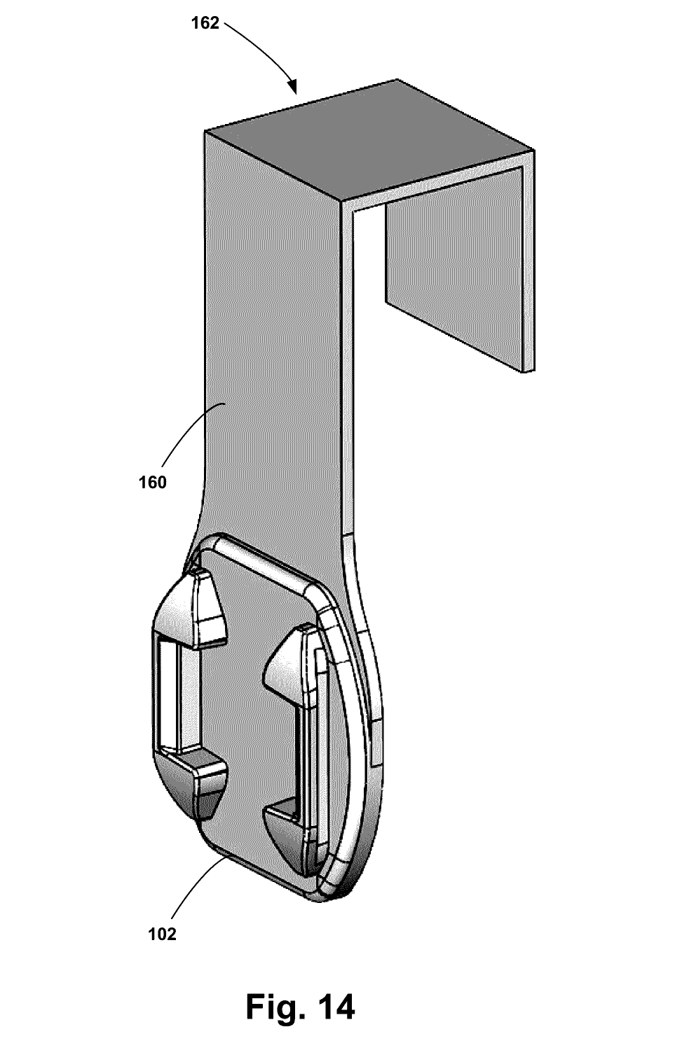

In yet another example, the bottom surface 106 of the mounting pad 102 may be coupled to an extension member 160, as shown in FIG. 14. The extension member 160 may be an integral component of the mounting pad 102 that is formed during manufacturing, or may be a separate component that is coupled to the mounting pad 102 after manufacturing the mounting pad 102. The first end of the extension member 160 may be coupled to the mounting pad 102. The second end of the extension member 160 may include a hook portion 162, which may be able to couple to a top surface of a door, a top surface of a shower door, a top of a chair, a pocket of a backpack or other bag, among other uses.

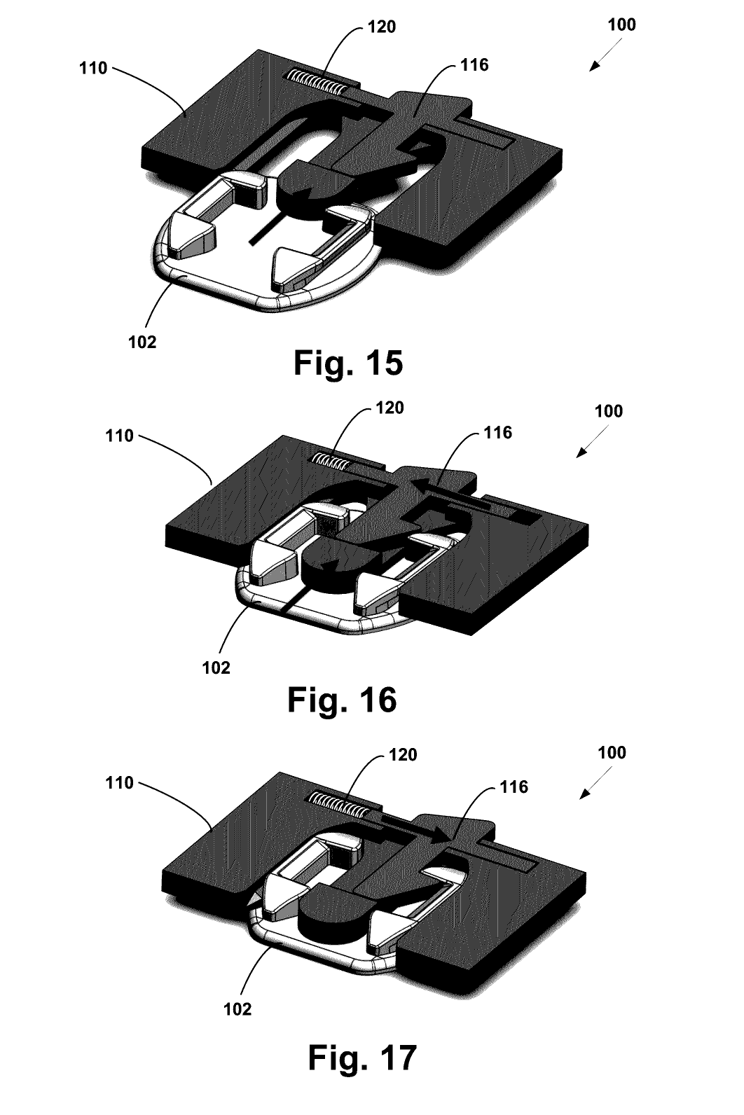

FIGS. 15-17 illustrate the mounting device 100 in operation, according to an example embodiment. In FIG. 14, the base plate 110 and the mounting pad 102 are lined up. The user pushes the bottom surface 114 of the base plate 110 along the top surface 104 of the mounting pad 102 once the two components are lined up. As shown in FIG. 15, when the mounting pad 102 and the snap lock 116 meet, the surfaces meet at approximately 30 degrees, causing the snap lock 116 to slide right from the first position (locked position) to the second position (unlocked position). As the angled surface 122 of the snap lock 116 clears the angled surface 109A, 109B of the extrusion 108B of the mounting pad 102, the base plate 110 can slide into its locked position. As shown in FIG. 16, the base plate 110 is locked in place via the snap lock 116. External forces applied to the base plate 110 can release the lock. Only moving the snap lock 116 from the first position to the second position will unlock the mechanism.

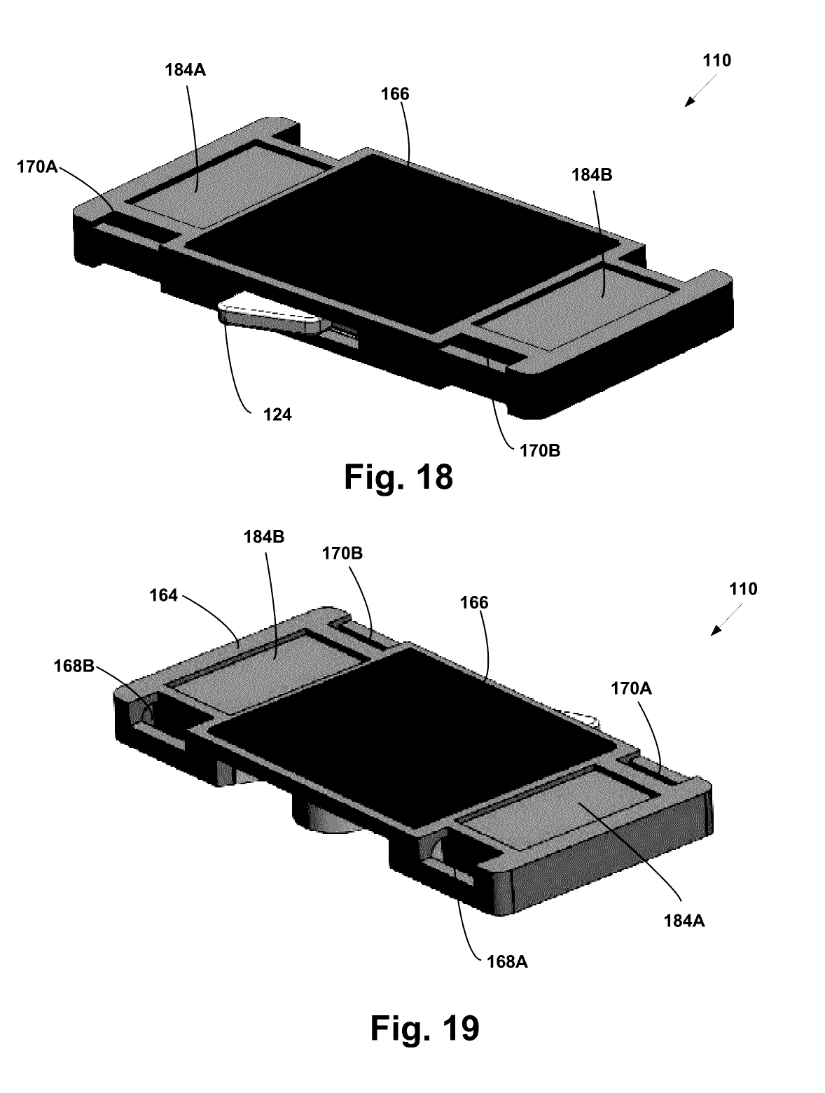

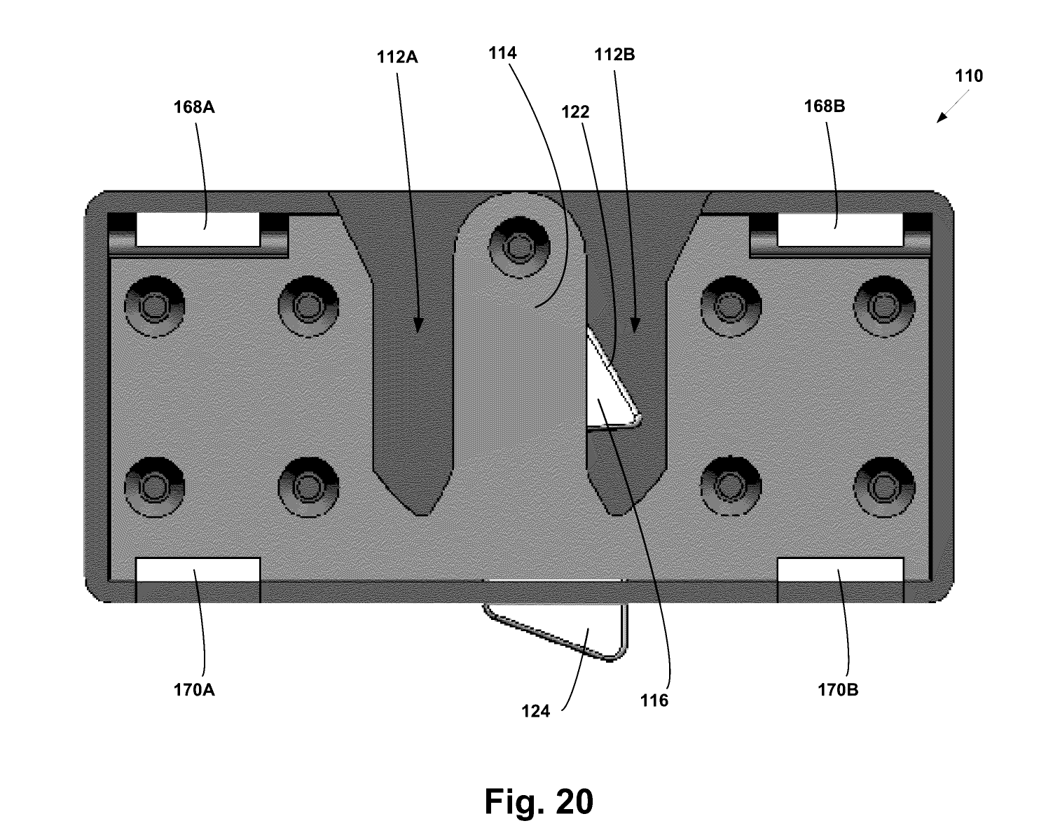

FIGS. 18-19 illustrate a perspective view of a top surface 164 of another example base plate 110 of a mounting device 100, according to an example embodiment. The top surface 164 of the base plate 110 may include a foam pad 166. In one example, the top surface 164 of the base plate 110 may include a cutout into which the foam pad 166 is placed. In another example, the foam pad 166 simply sits on a substantially planar top surface 164 of the base plate 110. As shown in FIG. 20, the bottom surface 114 of the base plate 110 may be coupled to the top surface 164 via a plurality of coupling mechanisms. These coupling mechanisms may be screws, or other coupling means.

Further, as illustrated in FIGS. 18-22, the base plate 110 may include a first set of slots 168A, 168B and a second set of slots 170A, 170B positioned opposite the first set of slots 168A, 168B. The first set of slots 168A, 168B may be configured to anchor a first end of a strapping mechanism to the base plate 110. In particular, a first strapping mechanism 172A may be anchored to a first slot 168A of the first set of slots, and a second strapping mechanism 172B may be anchored to a second slot 168B of the first set of slots. The strapping mechanisms 172A, 172B may be a hook-and-loop (e.g., Velcro®) strap, a belt and buckle strap, an adjustable side release buckle, or some other strapping mechanism. In one example, the first end 174 of the strapping mechanism 172A, 172B may include a piece of material 176 that is larger than the first set of slots 168A, 168B, such that the strapping mechanism 172A, 172B can pass through the first set of slots 168A, 168B, but the piece of material 176 prevents the first end 174 of the strapping mechanism 172A, 172B from passing through the first set of slots 168A, 168B. As such, the strapping mechanism 172A, 172B is thereby anchored to the base plate 110. In another example, the first end 174 of the strapping mechanism 172A, 172B may be anchored within the base plate 110 during manufacturing. In yet another example, the first end 174 of the strapping mechanism 172A, 172B may be anchored to the base plate 110 via a clasp, or some other coupling mechanism. Other examples are possible as well.

Once the first end 174 of the strapping mechanism 172A, 172B is anchored to the base plate 110, a second end 178 of the strapping mechanism 172A, 172B may be positioned through a first slot 170A of the second set of slots. The second end 178 of the strapping mechanism 172A, 172B may then be pulled back towards the first set of slots 168A, 168B to tighten the strapping mechanism 172A, 172B around an object positioned on the base plate. Once the first and second strapping mechanisms 172A, 172B are tightly positioned around the object, the second end 178 of the respective strapping mechanism 172A, 172B can be held in place. In the hook-and-loop strapping mechanism example, the second end 178 of each respective strapping mechanism 172A, 172B may include a hook portion on a first side of the strapping mechanism 172A, 172B, and the remaining first side of the strapping mechanism 172A, 172B may include a loop portion, such that the second end 178 can attach to the loop portion of the strapping mechanism 172A, 172B to hold the strapping mechanism 172A, 172B in place around the object.

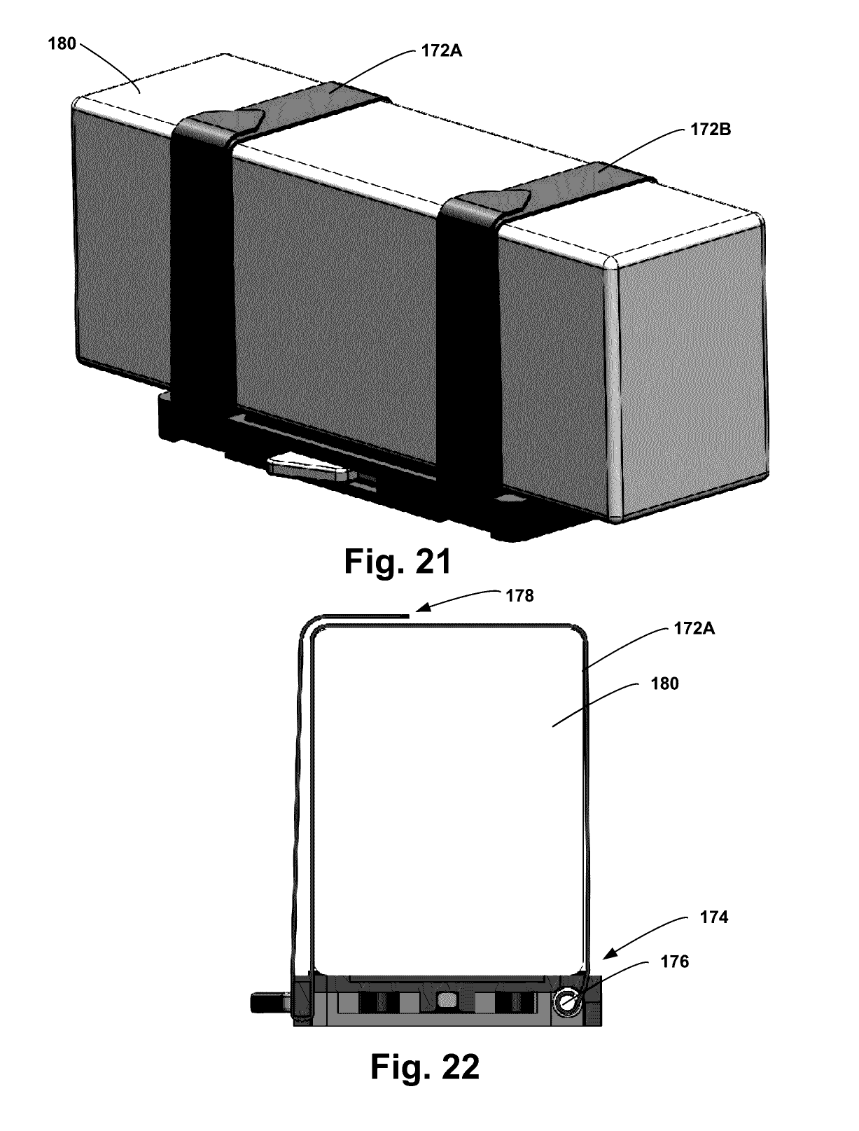

FIGS. 21-22 illustrate an example rectangular object 180 coupled to the base plate 110 of the mounting device 100 via a pair of strapping mechanisms 172A, 172B, according to an example embodiment. As described above and shown in FIG. 22, the first end 174 of each respective strapping mechanism 172A, 172B is anchored to the base plate 110 via the first set of slots 168A, 168B. The second end 178 of the strapping mechanism 172A, 172B is positioned over the object 180 to be held, through the second set of slots 170A, 170B, and back towards the first set of slots 168A, 168B until the strapping mechanism 172A, 172B is positioned tightly around the object 180. Once the first and second strapping mechanisms 172A, 172B are tightly positioned around the object 180, the second end 178 of the respective strapping mechanism 172A, 172B can be held in place, as described above. Although FIG. 22 illustrates the first strapping mechanism 172A, the second strapping mechanism 172B may be similarly configured.

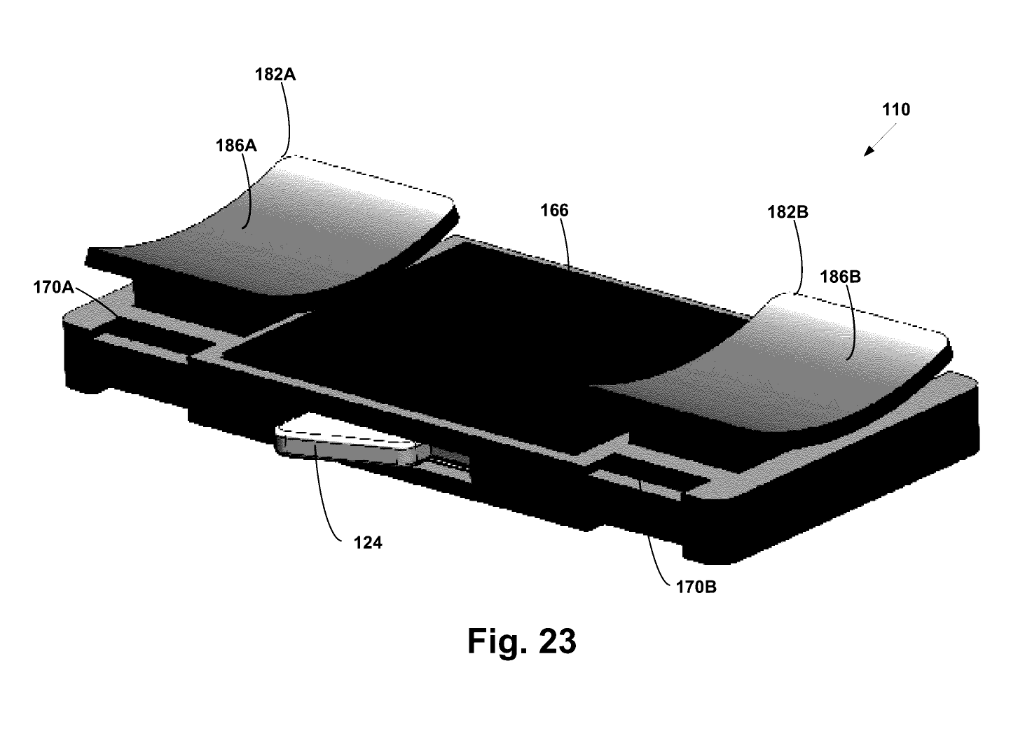

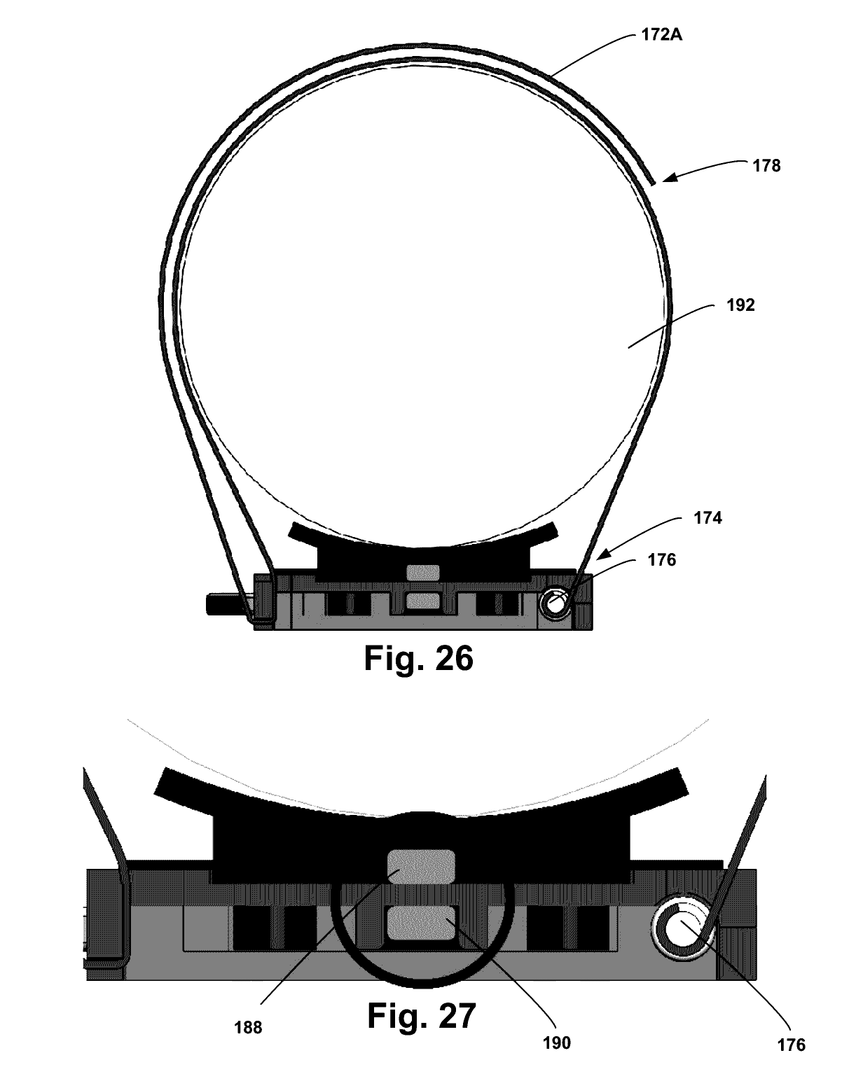

FIG. 23 illustrates a perspective view of the top surface 164 of the base plate 110 of the mounting device 100 including a pair of curve guides 182A, 182B, according to an example embodiment. As shown in FIGS. 18-19, the top surface 164 of the base plate 110 may include a pair of cutouts 184A, 184B positioned between the first set of slots 168A, 168B and the second set of slots 170A, 170B. A corresponding pair of curve guides 182A, 182B may be positioned within the pair of cutouts 184A, 184B on the top surface 164 of the base plate 110. In particular, a bottom surface of a given curve guide 182A, 182B may be dimensioned to fit within the corresponding cutout 184A, 184B. Further, a top surface 186A, 186B of a given curve guide may include a foam pad. The curve guides 182A, 182B may have a radius of curvature in the range of about 1.125 inches to about 2.375 inches. In one example, a first magnet 188 may be positioned within the bottom surface of the curve guides 182A, 182B, and a second magnet 190 may be positioned within the cutouts 184A, 184B on the base plate 110. As such, the curve guides 182A, 182B may be removably coupled to the base plate 110. Such a design may be advantageous to help hold the curve guides 182A, 182B in place while the user sets up the cylindrical object 192 onto the curve guides 182A, 182B before strapping the object 192 to the base plate 110. The magnetic design can be seen highlighted in FIGS. 26-27, for example.

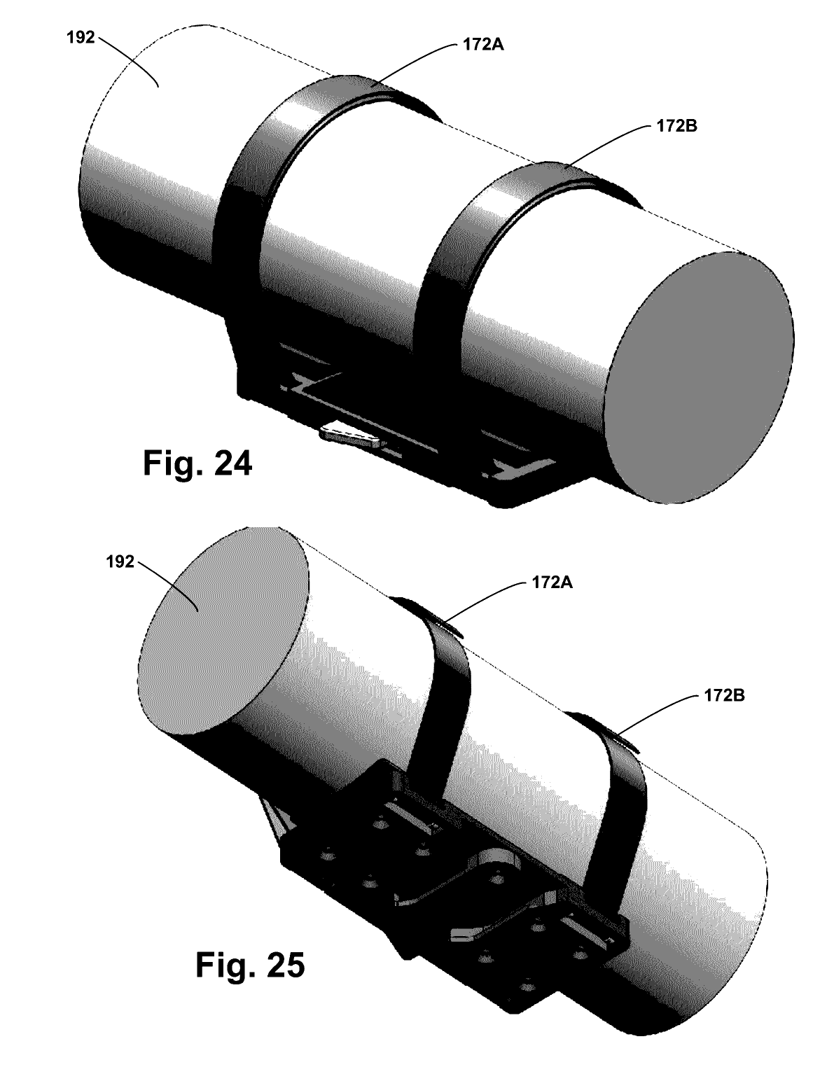

FIGS. 24-27 illustrate an example cylindrical object 192 coupled to the base plate 110 of the mounting device 100 via a pair of strapping mechanisms 172A, 172B, according to an example embodiment. As described above and shown in FIGS. 22-27, the first end 174 of each respective strapping mechanism 172A, 172B is anchored to the base plate 110 via the first set of slots 168A, 168B. The second end 178 of the strapping mechanism 172A, 172B is positioned over the object 192 to be held, through the second set of slots 170A, 170B, and back towards the first set of slots 168A, 168B until the strapping mechanism 172A, 172B is positioned tightly around the object 192. Once the first and second strapping mechanisms 172A, 172B are tightly positioned around the object 192, the second end 178 of the respective strapping mechanism 172A, 172B can be held in place, as described above. Although FIG. 26 illustrates the first strapping mechanism 172A, the second strapping mechanism 172B may be similarly configured.

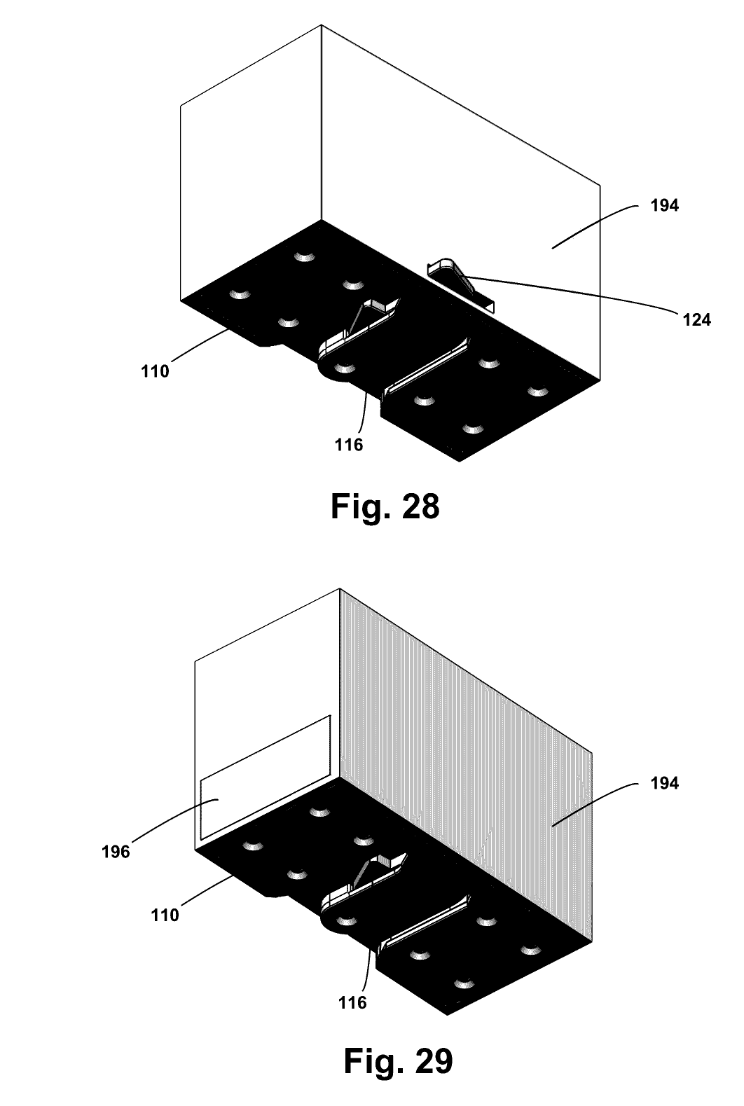

FIGS. 28-29 illustrate the base plate 110 built into an object 194, according to example embodiments. As shown in FIGS. 28-29, the base plate 110 may be built directly into the object 194 instead of using the strapping method described above. In various examples, the base plate 110 may be an integral component of the object 194 that is formed during manufacturing of the object, or the base plate 110 may be a separate component that is coupled to the mounting pad 102 after manufacturing the object 194. The base plate 110 may be built into any surface of the object 194, in this case, the bottom. In one example, as shown in FIG. 28, the snap lock 116 is moved with a swiping motion on a latch 124 on the front of the object 194, as previously described. In another example, as shown in FIG. 29, the front latch 124 is replaced with a button 196 on the side of the object 194. The button 196 may be circular or rectangular and may range in size from about 0.5 inches up to the size of the entire side of the object 194. The button 196 may be an extension of the snap lock 116 such that the snap lock 116 may be moved from the first position to the second position by pushing in the button 196, thereby releasing the object from the mounting pad 102.

Each of the components described above may represent modules that act as building blocks for more sophisticated mounting devices with amplified functionality. As such, the components described above may be stored as a digital file representing the structure of the component that can be manufactured using an additive-manufacturing technique, such as stereolithography. A user may then combine a plurality of such modules to create a more complicated mounting device, and subsequently manufacture the combined mounting device using an additive manufacturing system.

As such, each of the components described above may represent a module, a segment, or a portion of program code, which includes one or more instructions executable by a processor or computing device for creating such devices using an additive manufacturing system. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

The mounting device 100 described above may be used to couple many different devices to many different surfaces. In one specific example, a stereo may be coupled to the base plate 110. As such, the stereo may be temporarily mounted to the mounting pad 102 in a variety of situations. For example, the mounting pad 102 may be coupled to a boat, a golf cart, a lawnmower, a kayak, an ATV, or another vehicle. In another example, the mounting pad 102 may be coupled to a wall, a shower, or a ceiling. In another example, the mounting device 100 described above may be used to keep various electronics in place on a boat. For example, a boat with a kitchen may use the mounting device 100 to hold a coffee maker on a counter. Further still, the mounting device 100 may be used to secure non-electronic devices to various surfaces. As a specific example, the mounting device 100 may be used to secure outdoor decorations on the side of a house. As another specific example, the mounting device 100 may be used to secure a fire extinguisher to any suitable surface. Many other applications are possible as well. In such examples, the mounting device 100 may further include a cover plate 130 coupled to the base plate 110. The cover plate 130 may include a flat surface that may be used to couple the mounting device 100 to a given device. For example, double sided sticky tape positioned on the cover plate 130 may be used to couple the mounting device 100 to a given device. In another example, as discussed above in relation to FIGS. 28-29, the base plate 110 of the mounting device 100 may be built in to the object to be mounted. As such, the base plate 110 is formed as an integral part of the object to be mounted. In particular, the base plate 110 may be built into a digital camera for mounting to a given surface, or the back surface of a television for mounting to a wall surface. Other examples are possible as well.

One example method for temporarily mounting a device to a surface comprises (a) positioning a bottom surface of a mounting pad on the surface, wherein a top surface includes a pair of extrusions, (b) positioning a snap lock within a channel in a base plate, wherein the base plate includes a pair of cutouts, and wherein the snap lock is moveable between a first position and a second position within the channel in the base plate, and (c) sliding a bottom surface of the base plate along the top surface of the mounting pad until the snap lock moves from the second position to the first position, thereby coupling the base plate to the mounting pad.

In one example, the method further includes (d) sliding the snap lock from the first position to the second position via a latch extending from the snap lock, and (e) sliding the bottom surface of the base plate along the top surface of the mounting pad in a direction towards the latch to decouple the base plate from the mounting pad.

In another example, the base plate is formed as an integral part of the device. In such an example, the method further includes (d) sliding the snap lock from the first position to the second position via a button on a side of the device, and (e) sliding the bottom surface of the base plate along the top surface of the mounting pad to decouple the base plate from the mounting pad.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense. Further, it is intended to be understood that the following clauses (and any combination of the clauses) further describe aspects of the present description.

What is claimed is:

1. A mounting device, comprising:
a mounting pad having a top surface and a bottom surface, wherein the top surface includes a pair of extrusions;
a base plate including a pair of cutouts, wherein a bottom surface of the base plate contacts the top surface of the mounting pad such that the pair of cutouts are positioned around the pair of extrusions;
a snap lock moveable between a first position and a second position within a channel in the base plate, wherein the snap lock couples the base plate to the mounting pad in the first position, and wherein the snap lock decouples the base plate from the mounting pad in the second position; and
a biasing element positioned within the channel in the base plate, wherein the biasing element biases the snap lock to the first position.

2. The mounting device of claim 1, wherein the snap lock is moveable from the first position to the second position via a latch extending from the base plate.

3. The mounting device of claim 1, wherein the pair of extrusions of the mounting pad include an angled surface on an outer edge of the extrusions, and wherein the base plate includes complementary angled surfaces on an outer edge of the pair of cutouts.

4. The mounting device of claim 1, wherein the mounting pad includes a mounting mechanism for mounting the bottom surface of the mounting pad to a surface.

5. The mounting device of claim 4, wherein the mounting mechanism comprises one of a permanent sticky pad, a temporary sticky pad, a suction cup, a bolt mount, a strap mount, a magnet mount, a clamp mount, a handle bar mount, or a rotatable mount.

6. The mounting device of claim 1, wherein the biasing element comprises a compression spring.

7. The mounting device of claim 1, wherein the snap lock includes an angled surface, such that as the angled surface contacts one of the pair of extrusions of the mounting pad the snap lock moves from the first position to the second position.

8. The mounting device of claim 1, wherein a top surface of the base plate includes a foam pad.

9. The mounting device of claim 1, further comprising:
a first slot in the base plate;
a second slot in the base plate positioned on an opposite side of the base plate as the first slot;
a third slot in the base plate positioned on the same side of the base plate as the first slot; and
a fourth slot in the base plate positioned opposite on an opposite side of the base plate as the third slot.

10. The mounting device of claim 9, further comprising:
a first strapping mechanism having a first end and a second end, wherein the first end of the first strapping mechanism is anchored to the base plate via the first slot, and wherein the second end of the first strapping mechanism passes through the second slot and is coupled to the first strapping mechanism; and
a second strapping mechanism having a first end and a second end, wherein the first end of the second strapping mechanism is anchored to the base plate via the third slot, and wherein the second end of the second strapping mechanism passes through the second slot and is coupled to the strapping mechanism.

11. The mounting device of claim 10, wherein the first and second strapping mechanisms comprise one of a hook-and-loop strap or a belt and buckle strap.

12. The mounting device of claim 1, further comprising:
a first curve guide removably positioned on a top surface of the base plate; and
a second curve guide removably positioned on the top surface of the base plate.

13. The mounting device of claim 12, wherein the top surface of the base plate includes a first cutout and a second cutout, wherein a bottom surface of the first curve guide is dimensioned to fit within the first cutout, and wherein a bottom surface of the second curve guide is dimensioned to fit within the second cutout.

14. The mounting device of claim 12, wherein a top surface of the first curve guide includes a first foam pad, and wherein a top surface of the second curve guide includes a second foam pad.

15. The mounting device of claim 12, wherein a top surface of the first curve guide and a top surface of the second curve guide have a radius of curvature in the range of about 1.125 inches to about 2.375 inches.

16. The mounting device of claim 12, further comprising:
a first magnet positioned within the first curve guide;
a second magnet positioned within the second curve guide;
a third magnet positioned within the base plate, wherein the first magnet and third magnet interact to removably positioned the first curve guide on the top surface of the base plate; and
a fourth magnet positioned within the base plate, wherein the second magnet and fourth magnet interact to removably positioned the second curve guide on the top surface of the base plate.

17. The mounting device of claim 1, further comprising:
an extension member having a first end and a second end, wherein the first end of the extension member is coupled to the mounting pad; and
a hook positioned on the second end of the extension member.

18. The mounting device of claim 1, wherein the base plate is formed as an integral part of an object to be mounted to the mounting pad.

19. The mounting device of claim 18, wherein the snap lock is moveable from the first position to the second position via a button on a side of the object.

20. A method for temporarily mounting a device to a surface, comprising:
positioning a bottom surface of a mounting pad on the surface, wherein a top surface of the mounting pad includes a pair of extrusions;
positioning a snap lock within a channel in a base plate, wherein the base plate includes a pair of cutouts, and wherein the snap lock is moveable between a first position and a second position within the channel in the base plate;
sliding a bottom surface of the base plate along the top surface of the mounting pad until the snap lock moves from the second position to the first position, thereby coupling the base plate to the mounting pad.

21. The method of claim 20, further comprising:
sliding the snap lock from the first position to the second position via a latch extending from the snap lock; and
sliding the bottom surface of the base plate along the top surface of the mounting pad in a direction towards the latch to decouple the base plate from the mounting pad.

22. The method of claim 20, wherein the base plate is formed as an integral part of the device, the method further comprising:
sliding the snap lock from the first position to the second position via a button on a side of the device; and
sliding the bottom surface of the base plate along the top surface of the mounting pad to decouple the base plate from the mounting pad.
